(19) United States
(12) Patent Application Publication
(10) Pub. No.: US 2024/0080773 A1
(43) Pub. Date: Mar. 7, 2024

(54) PRIORITIZING CELL SELECTION IN A USER EQUIPMENT

(71) Applicant: QUALCOMM Incorporated, San Diego, CA (US)

(72) Inventors: Ansah Ahmed SHEIK, Hyderabad (IN); Chinmaya PADHY, Hyderabad (IN)

(21) Appl. No.: 17/939,855

(22) Filed: Sep. 7, 2022

(51) Int. Cl. H04W 52/02; H04W 36/08; H04W 48/20; H04W 76/28

(52) U.S. Cl. CPC H04W 52/028; H04W 36/08; H04W 48/20; H04W 52/0232; H04W 76/28

(57) ABSTRACT

The aspects described herein provide a user equipment (UE) for wireless communication with improved cell reselection performance A UE receives cell information for a plurality of cells and processes the received cell information to determine one or more cells of the plurality of cells having enabled power-saving features, based on an acquisition database. The UE prioritizes an order of cell selection, using the processed cell information, based on one or more cells having a largest number of enabled power-saving features. The UE then selectively communicates with at least one cell, based on the prioritized order, when the UE is in a configured operating condition.

### BACKGROUND

### Technical Field

The present disclosure relates generally to communication systems, and more particularly, to prioritizing cell selection in a user equipment (UE), based on power-saving features.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term. Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may transition from a connected mode to an idle mode due to certain operating conditions and/or events, such as a radio link failure, inactivity for a period of time, etc. To facilitate connecting (reconnecting) to a cell in a wireless network, the UE may use an acquisition database including cell identification information for a plurality of cells of a radio access technology (RAT). However, when the UE is in a low battery state (e.g., a remaining battery power of the UE is below a threshold), the UE may not identify and select the best cell (from the acquisition database) in terms of enabled power-saving features for improving (e.g., reducing) power consumption at the UE. As a result, the operating time of the UE may be reduced. The aspects described herein allow a UE to overcome these issues.

In some examples, a method of user equipment (UE) communication on a wireless network is disclosed, comprising: receiving cell information for a plurality of cells; processing the received cell information to determine one or more cells of the plurality of cells having enabled power-saving features, based on an acquisition database; prioritizing an order of cell selection, using the processed cell information, based on one or more cells having a largest number of enabled power-saving features; and selectively communicating with at least one cell, based on the prioritized order, when the UE is in a configured operating condition.

In some examples, a user equipment (UE) for communicating on a wireless network is disclosed, comprising: a memory; and at least one processor coupled to the memory and configured to receive cell information for a plurality of cells; process the received cell information to determine one or more cells of the plurality of cells having enabled power-saving features, based on an acquisition database; prioritize an order of cell selection, using the processed cell information, based on one or more cells having a largest number of enabled power-saving features; and selectively communicate with at least one cell, based on the prioritized order, when the UE is in a configured operating condition.

In some examples, a non-transitory computer-readable medium storing code for wireless communication at a user equipment (UE), the code comprising instructions executable by a processor to: receive cell information for a plurality of cells; process the received cell information to determine one or more cells of the plurality of cells having enabled power-saving features, based on an acquisition database; prioritize an order of cell selection, using the processed cell information, based on one or more cells having a largest number of enabled power-saving features; and selectively communicate with at least one cell, based on the prioritized order, when the UE is in a configured operating condition.

In some examples, an apparatus and method are disclosed for wireless communication at a base station (BS), comprising: a memory; and at least one processor coupled to the memory and configured to: transmit, to a user equipment (UE), cell information comprising enabled power-saving features of the BS for processing in an acquisition database of the UE; and receive selective communication from the UE responsive to the transmitted cell information, wherein the selective communication is based on a prioritized order of cell selection, relating to the number of enabled power-saving features on the BS.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture according to some aspects of the present disclosure.

FIG. 5 is a block diagram illustrating a radio protocol architecture for the user and control planes according to some aspects.

FIG. 6 is a block diagram illustrating an example of a wireless communication system in which a UE is configured to scan for service according to some aspects.

FIGS. 7A and 7B illustrate acquisition databases (ACQ DB) used in a wireless communication system for receiving a number of power features included in each of a plurality of cells for prioritizing cell connections according to some aspects.

FIG. 8 illustrates a signal flow diagram for prioritizing cell connections according to some aspects.

FIG. 9 illustrates a discontinuous reception (DRX) operation including a long DRX cycle according to some aspects.

FIG. 10 illustrates an example of a wake-up signal function in a UE according to some aspects.

FIG. 11 illustrates an example of a physical downlink control channel (PDCCH) skipping function in a UE according to some aspects.

FIG. 12 illustrates an example of an early page function in a UE according to some aspects.

FIG. 13 is a conceptual diagram illustrating an example of a hardware implementation for an exemplary UE employing a processing system according to some aspects.

FIG. 14 is a diagram illustrating an example of a hardware implementation for an apparatus.

FIG. 15 is a flow chart of a method for a UE communicating on a wireless network under some aspects of the present disclosure.

FIG. 16 is a flow chart of a method for a UE communicating on a wireless network under some aspects of the present disclosure.

FIG. 17 is a flow chart of a method for a base station (BS) communicating on a wireless network under some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

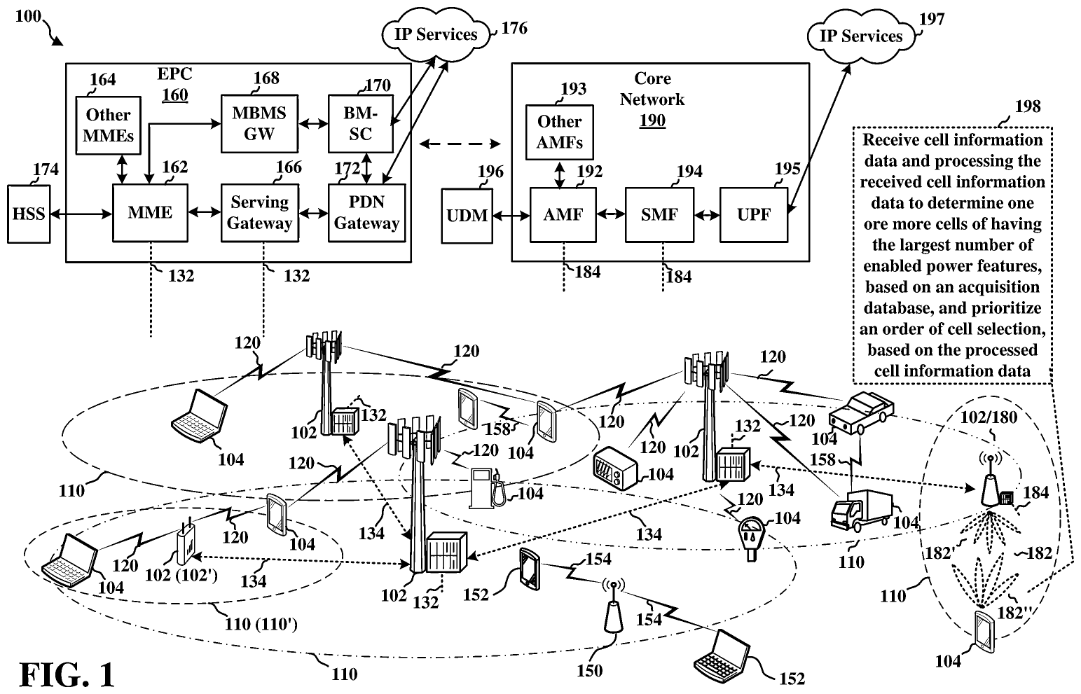

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSSCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions, including serving as an anchor point for infra-/inter-radio access technology (RAT) mobility. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to receive cell information data for a plurality of cells, including a number of enabled power features associated with each of the plurality of cells, where the UE 104 may process the received cell information data to determine one or more cells of the plurality of cells having the largest number of enabled power features, based on an acquisition database, and prioritize an order of cell selection, based on the processed cell information data having a largest number of enabled power features (198). Although the following description may be focused on 5G NR, the concepts described herein may be applicable to other similar areas, such as LTE, LTE-A, CDMA, GSM, and other wireless technologies.

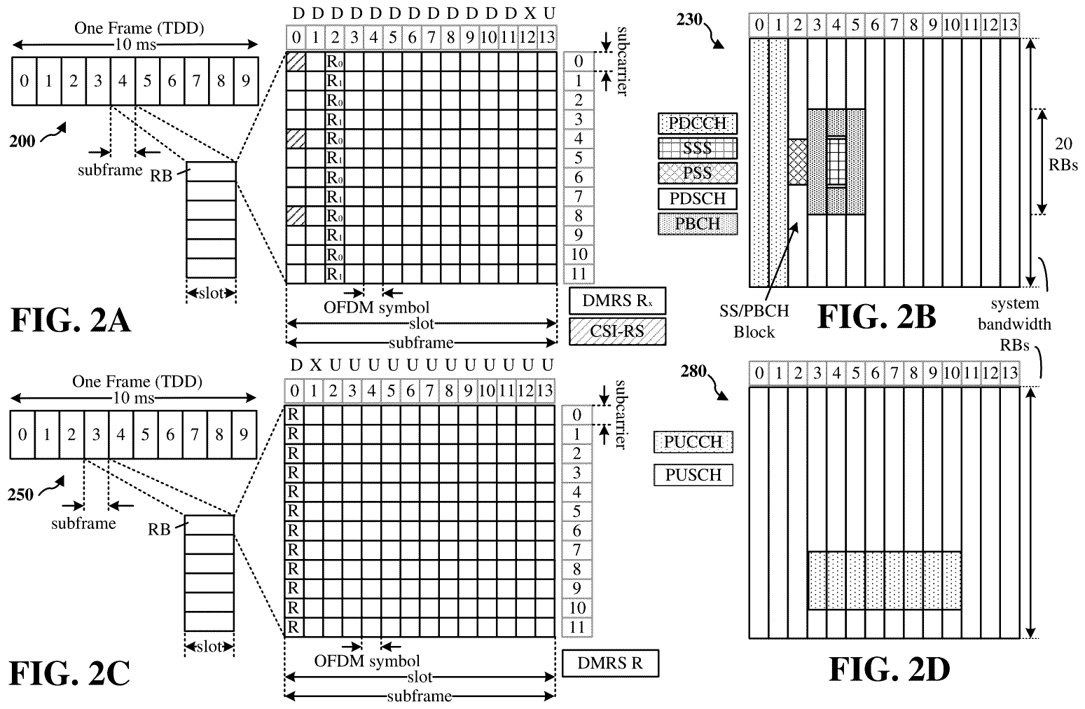

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2^{μ} slots/subframe. The subcarrier spacing and symbol length/duration are a function of the numerology. The subcarrier spacing may be equal to 2^{μ}*15 kKz, where it is the numerology 0 to 5. As such, the numerology p=0 has a subcarrier spacing of 15 kHz and the numerology p=5 has a subcarrier spacing of 480 kHz. The symbol length/duration is inversely related to the subcarrier spacing. FIGS. 2A-2D provide an example of slot configuration 0 with 14 symbols per slot and numerology p=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal. (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) caries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

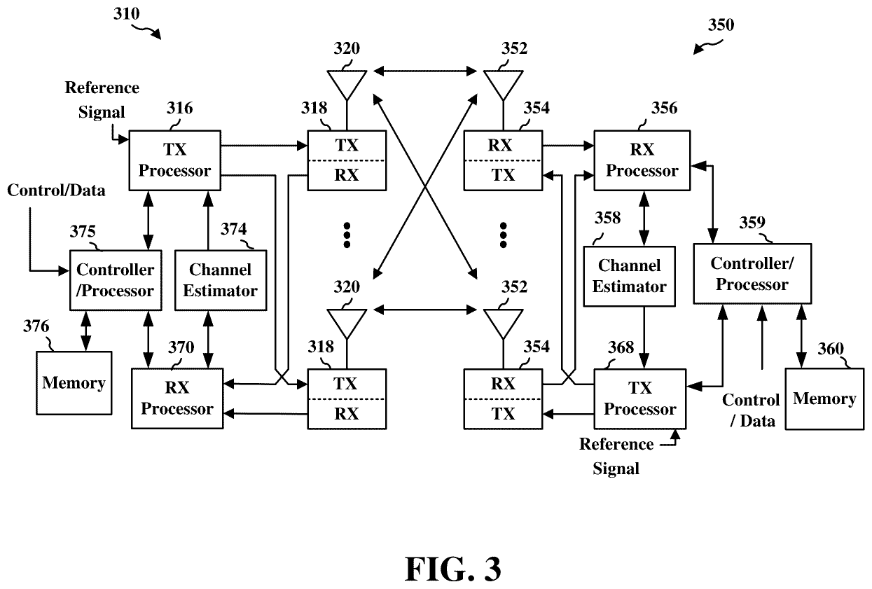

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN ((such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRY), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

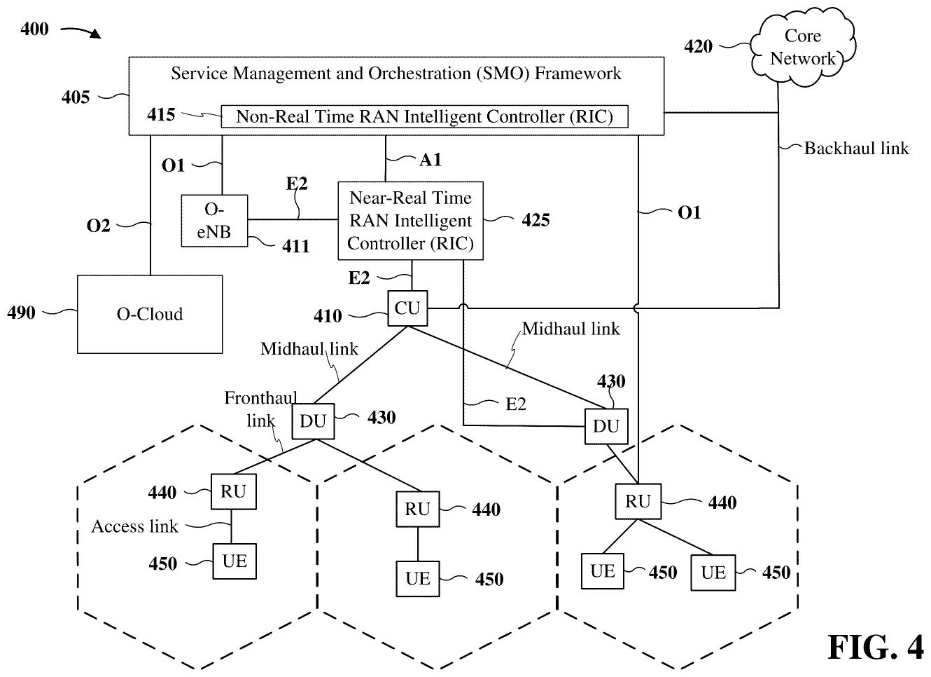

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 450 via one or more radio frequency (RF) access links. In some implementations, the UE 450 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

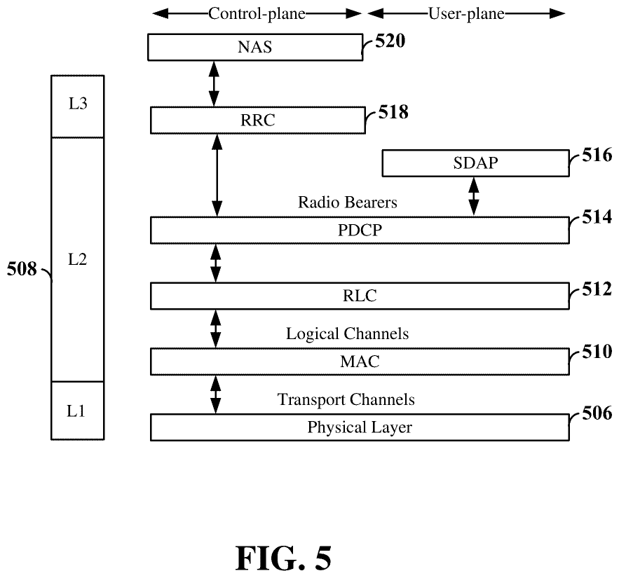

FIG. 5 is a block diagram illustrating a radio protocol architecture for the user and control planes of a UE according to some aspects. The radio protocol architecture for a radio access network, such as the radio access network shown in FIG. 1 and/or FIG. 3, may take on various forms depending on the particular application. An example of a radio protocol architecture for the user and control planes is illustrated FIG. 3.

As illustrated in FIG. 5, the radio protocol architecture for the UE and the base station includes three layers: layer 1 (L1), layer 2 (L2), and layer 3 (L3). L1 is the lowest layer and implements various physical layer signal processing functions. L1 will be referred to herein as the physical layer 506. L2 508 is above the physical layer 506 and is responsible for the link between the UE and base station over the physical layer 506.

In the user plane, the L2 layer 508 includes a media access control (MAC) layer 510, a radio link control (RLC) layer 512, a packet data convergence protocol (PDCP) 514 layer, and a service data adaptation protocol (SDAP) layer 516, which are terminated at the base station on the network side. Although not shown, the UE may have several upper layers above the L2 layer 508 including at least one network layer (e.g., IP layer and user data protocol (UDP) layer) that is terminated at the User Plane Function (UPI) on the network side and one or more application layers.

The SDAP layer 516 provides a mapping between a 5G core (5GC) quality of service (QoS) flow and a data radio bearer and performs QoS flow ID marking in both downlink and uplink packets. The PDCP layer 514 provides packet sequence numbering, in-order delivery of packets, retransmission of PDCP protocol data units (PDUs), and transfer of upper layer data packets to lower layers. PDU's may include, for example, Internet Protocol (IP) packets, Ethernet frames and other unstructured data (i.e., Machine-Type Communication (MTC), hereinafter collectively referred to as “packets”). The PDCP layer 514 also provides header compression for upper layer data packets to reduce radio transmission overhead, security by ciphering the data packets, and integrity protection of data packets. A PDCP context may indicate whether PDCP duplication is utilized for a unicast connection.

The RLC layer 512 provides segmentation and reassembly of upper layer data packets, error correction through automatic repeat request (ARQ), and sequence numbering independent of the PDCP sequence numbering. An RLC context may indicate whether an acknowledged mode (e.g., a reordering timer is used) or an unacknowledged mode is used for the RLC layer 512. The MAC layer 510 provides multiplexing between logical and transport channels. The MAC layer 510 is also responsible for allocating the various radio resources (e.g., resource blocks) in one cell among the UEs and for HARQ operations. A MAC context may enable, for example, a HARQ feedback scheme, resource selection algorithms, carrier aggregation, beam failure recovery, or other MAC parameters for a unicast connection. The physical layer 506 is responsible for transmitting and receiving data on physical channels (e.g., within slots). A PHY context may indicate a transmission format and a radio resource configuration (e.g., bandwidth part (BWP), numerology, etc.) for a unicast connection.

In the control plane, the radio protocol architecture for the UE and base station is substantially the same for L1 506 and L2 508 with the exception that there is no SDAP layer in the control plane and there is no header compression function for the control plane. The control plane also includes a radio resource control (RRC) layer 518 in L3 and a higher Non-Access Stratum (NAS) layer 520. The RRC layer 518 is responsible for establishing and configuring signaling radio bearers (SRBs) and data radio bearers (DRBs) between the base station the UE, paging initiated by the 5GC or NG-RAN, and broadcast of system information related to Access Stratum (AS) and Non-Access Stratum (NAS). The RRC layer 518 is further responsible for QoS management, mobility management (e.g., handover, cell selection, inter-RAT mobility), UE measurement and reporting, and security functions. The NAS layer 520 is terminated at the AMF in the core network and performs various functions, such as authentication, registration management, and connection management.

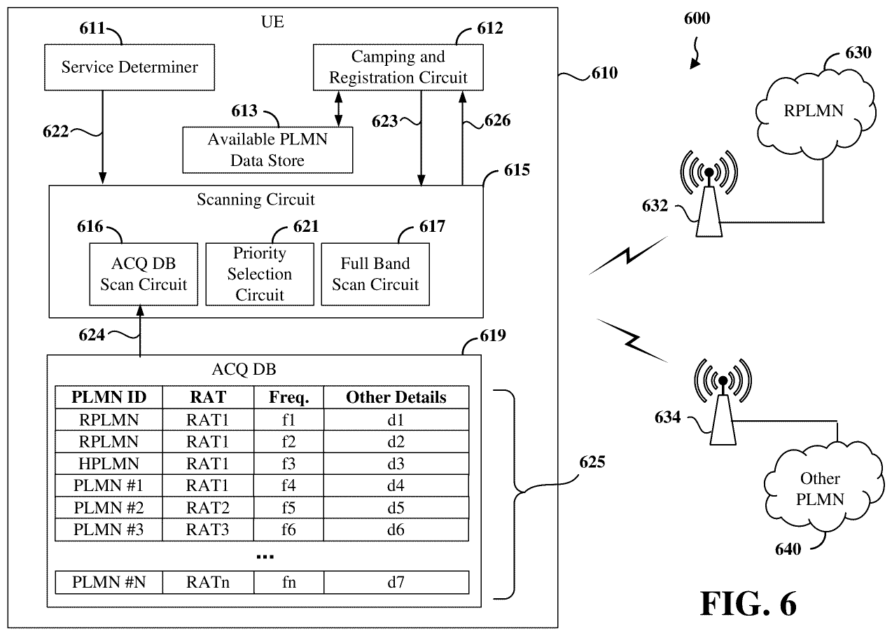

FIG. 6 shows a block diagram 600 illustrating an example of a wireless communication system in which a UE 610 (also referred to as a wireless communication device) is configured to scan for service according to some aspects. In some examples, the UE 610 may be configured to connect to a base station (e.g., base station 632, 634) utilizing an initial scan to determine available networks. In some examples, that UE 610 may perform a scan based on an acquisition database scan (e.g., via an acquisition database (ACQ DB) scan circuit 616) as well as a full band scan (e.g., via a full band scan circuit 617) for all supported RATs and/or on a RAT-by-RAT basis.

In this example, the UE 610 is shown as being in communication with a base station 632 associated with a registered public land mobile network (RPLMN) 630 and a base station 634 associated with a public land mobile network (PLMN) 640, which may be a PLMN other than RPLMN 630. Although, only two base stations are shown in FIG. 6, it will be appreciated that UE 610 may be in communication with any number of base stations associated with any number of PLMNs at the same time or at different times. Furthermore, and in an aspect, the UE 610 may be a multi-mode UE and, as such, may be in communication with at least the base station 632 and the base station 634 using one or more radio access technologies (RATs), including, in a non-liming example, for example, UMTS, GSM, LTE, or the like, and/or according to any number of wireless communication standards.

In an aspect, the UE 610 also may be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a scheduled entity, or some other suitable terminology.

In an aspect, the base station 632 and/or the base station 634, which also may be referred to as an access point or node, may be a macro cell, pico cell, small cell, relay, Node B, eNodeB, mobile Node B, scheduling entity, or substantially any type of component that can communicate with UE 610 to provide wireless network access.

In an aspect, the UE 610 includes a service determiner 611, which may be configured to determine that the UE 610 is configured in a current operating condition. The operating condition may include, but is not limited to, an out-of-service (00S) state as a result of detecting that UE 610 was recently powered on and/or is otherwise without service (e.g., radio link failure (RLF)), and/or if the UE 610 is in a low battery state. If so, then the service determiner 611 may communicate an out of service or no service indication 622 to scanning circuit 615 to request performance of a scan for service. In an additional aspect, service determiner 611 may also be configured to determine a PLMN to which the UE 610 was most recently registered, such as the RPLMN 630 and/or a RAT on which the UE 610 was most recently camped.

In some examples, the UE 610 may be considered to be in a low battery state when a battery level (e.g., an amount of energy remaining in a battery of the UE 610) of the UE 610 is below a threshold value. In some examples, the identity of the RPLMN 630 and the identity of the most recent RAT may be communicated to the scanning circuit 615 as part of the out of service indication 622. In an additional aspect, the identity of the RPLMN 630 and the identity of the most recent RAT may be determined by another component or components and communicated to the scanning circuit 615 in some other manner.

In an aspect, UE 610 includes the scanning circuit 615 configured to scan for service at the UE 610, which may include a scan for service as part of a cell reselection. The scanning circuit 615 may be configured to receive the out of service indication 622 from the service determiner 611, which may, in an aspect, include the identity of the RPLMN 630 and the identity of the most recent RAT. In response, the scanning circuit 615 may be configured to activate an acquisition database (ACQ DB) scan circuit 616 to begin scanning at a first frequency associated with the most recent RAT and/or the RPLMN 630. To do so, the ACQ DB scan circuit 616 may be configured to communicate with an ACQ DB 619 to retrieve a first frequency, which may be communicated as one or more PLMN-RAT-frequency combinations 624. From the PLMN-RAT-frequency combination(s) 624, the ACQ DB scan circuit 616 may be configured to select the first frequency for scanning associated with the most recent RAT and the RPLMN 630 based on, for example, a priority system, a predetermined order, a dynamically changeable order, a user-defined order, and/or any other method. As will be explained in greater detail below, a priority selection circuit 621 may be configured to select a RAT according to a priority, based on a number of power-saving features indicated in the ACQ DB 619.

In an aspect, the UE 610 includes the ACQ DB 619, which may be a data store, memory, or some other component suitable for storing data. In some examples, the ACQ DB 619 may store information related to PLMN-RAT-frequency combinations 625 that are most likely to yield service acquisition for the UE 610. In this example, the PLMN-RAT-frequency combinations 625 in the ACQ DB 619 may be preconfigured by one or more users of the UE 610, one or more wireless service providers associated with the UE 610, a manufacturer of the UE 610, a network operator, or the like. In an aspect, the PLMN-RAT-frequency combinations 625 in the ACQ DB 619 may be dynamically adjusted, updated, and/or changed by one or more users of the UE 610, one or more wireless service providers associated with the UE 610, a manufacturer of the UE 610, a network operator, or the like.

In one example, the ACQ DB 619 may include the PLMN-RAT-frequency combinations 625 as a chart, list, or other correlated data format, which includes entries. An entry may include a PLMN identifier (ID), which may be, for example, an indication of a wireless service provider associated with a PLMN (e.g., Wireless Carrier A, Wireless Carrier B, or the like) and/or an indication as to whether a PLMN is the registered PLMN (RPLMN), a home PLMN (HPLMN) with which the UE 610 is associated, or a visited PLMN (VPLMN). An entry may further include a RAT (e.g., GSM, UMTS, LTE, or the like), a frequency (e.g., a frequency value in units of megahertz (MHz)), and additional information or other details related to the PLMN-RAT-frequency combination of the particular entry. The other details for each entry may include, in a non-limiting example, one or more of a time stamp information (e.g., when an entry was added to the ACQ DB 619, when the PLMN-RAT-frequency combination was identified, or the like), further identifying information for any of the RPLMN, RAT, or frequency in the entry, and/or any information related to acquiring service according to the PLMN-RAT-frequency combination.

The ACQ DB scan circuit 616 may be configured to scan a first frequency associated with the most recent RAT and/or the RPLMN. For example, the most recent RAT may be the RAT the UE 610 previously camped on prior to entering the OOS state. If the ACQ DB scan circuit 616 determines that service was not acquired based on scanning the first frequency associated with the most recent RAT/RPLMN because, for example, the UE 610 did not identify a signal on which service may be acquired, the ACQ DB scan circuit 616 may be configured to scan for a second frequency associated with the most recent RAT and/or /RPLMN. To do so, the ACQ DB scan circuit 616 may, in an aspect, be configured to again refer to the PLMN-RAT-frequency combination(s) 624 if more than one frequency for the most recent RAT and/or RPLMN were provided therein. In another aspect, the ACQ DB scan circuit 616 may be configured to communicate with the ACQ DB 619 to retrieve another PLMN-RAT-frequency combination 624 such that it may select a second frequency associated with the most recent RAT and/or RPLMN. The ACQ DB scan circuit 616 may be configured to continue this process until it either identifies a signal on which service may be acquired, or it exhausts all frequencies of the most recent RAT and/or RPLMN.

Alternatively or in addition, in an aspect, upon completing scanning all frequencies paired with the first RAT and/or the RPLMN, if the ACQ DB scan circuit 616 has not identified a signal on which service may be acquired, the ACQ DB scan circuit 616 may be configured to communicate that it has not identified a signal on which service may be acquired to a camping and registration circuit 612 as a scan result 626.

In some examples, the UE 610 includes the camping and registration circuit 612 configured to receive the scan result 626 and attempt to register the UE 610 with the RPLMN. If the scan result 626 includes an indication that a signal on which service may be acquired was identified by the ACQ DB scan circuit 616, the camping and registration circuit 612 may be configured to camp on and attempt to register with the RPLMN. If the scan result 626 includes an indication that the ACQ DB scan circuit 616 completed scanning all frequencies for the most recent RAT associated with the RPLMN, and no frequencies for camping are found, the camping and registration circuit 612 may be configured to send a list of available PLMNs to the NAS when the scanning circuit 615 determines that at least one frequency associated with the most recent RAT or RPLMN is not found during the scanning of the one or more frequencies of the most recent RAT based on the ACQ DB 619.

The camping and registration circuit 612 may be configured to determine whether a home public land mobile network (HPLMN) is included within the list of all available PLMNs retrieved from an available PLMN data store 613. If so, the camping and registration circuit 612 may be configured to attempt to register with an HPLMN. If such registration is successful, the UE 610 acquires service and the processing described herein ends. If such registration is not successful and/or an HPLMN is not included within the list of all available PLMNs, the camping and registration circuit 612 may be configured to communicate a registration failure indication 623 to the scanning circuit 615. In an additional aspect, NAS may send a request to the UE 610 to switch to a different RAT (e.g., second RAT) and to scan frequencies of the second RAT for service. For example, the scanning circuit 615 may be configured to switch the UE 610 from one RAT (e.g., most recent RAT) to a second RAT as the UE 610 is a multi-mode UE that is capable of supporting multiple RATs for acquiring service.

In some examples, the ACQ DB scan circuit 616 may also be configured to scan one or more frequencies of the second RAT based on the acquisition database. If the ACQ DB scan circuit 616 determines that service was not acquired based on scanning the first frequency of the second RAT because, for example, the UE 610 did not identify a signal associated with the first frequency associated with the second RAT (e.g., RAT2) on which service may be acquired, the ACQ DB scan circuit 616 may be configured to scan for a second frequency associated with the second RAT. To do so, the ACQ DB scan circuit 616 may, in an aspect, be configured to again refer to the PLMN-RAT-frequency combination(s) 624 if more than one frequency for the second RAT were provided therein. The ACQ DB scan circuit 616 may be configured to continue this process until it either identifies a signal on which service may be acquired, or it exhausts all frequencies of the second RAT.

In an aspect, the scanning circuit 615 may be configured to receive a registration failure indication 623 from the camping and registration circuit 612. In response, the scanning circuit 615 may be configured to activate full band scan circuit 617 to begin performing full band scans, for example, of one or more frequencies, associated with the most recent RAT and/or the RPLMN 630. To do so, the full band scan circuit 617 may be configured to retrieve information related to frequencies associated with the most recent RAT and/or the RPLMN 630.

In an aspect, the full band scan circuit 617 may be configured to scan frequencies of the full band associated with the most recent RAT and/or the RPLMN. If the full band scan circuit 617 identifies a signal on which service may be acquired, it may be configured to communicate information related to the identified signal, including, for example, a corresponding frequency, RAT, PLMN, and/or other information, to the camping and registration circuit 612 as the scan result 626. In response, and as described herein, the camping and registration circuit 612 may be configured to attempt to register with the RPLMN. If the full band scan circuit 617 does not identify a signal associated with the RPLMN on which service may be acquired, the full band scan circuit 617 may be configured to communicate that it has not identified a signal on which service may be acquired to the camping and registration circuit 612 as the scan result 626. Additionally, in an aspect, the camping and registration circuit 612 may be configured to send a list of available PLMNs to the NAS when the full band scan circuit 617 determines that at least one frequency associated with the most recent RAT and/or RPLMN is not found during the full band scan of the one or more frequencies of the most recent RAT.

In some examples, the camping and registration circuit 612 may be configured to determine whether a home public land mobile network (HPLMN) is included within the list of all available PLMNs retrieved from available PLMN data store 613. If so, the camping and registration circuit 612 may be configured to attempt to register with the HPLMN. If such registration is successful, the UE 610 acquires service and the processing described herein ends. If such registration is not successful and/or the HPLMN is not included within the list of all available PLMNs, the camping and registration circuit 612 may be configured to communicate a registration failure indication 623 to the full band scan circuit 617. In an additional aspect, the NAS may send a request to the UE 610 to switch to a different RAT (e.g., a second RAT) and to perform a full band scan of the different RAT for service. For example, the full band scan circuit 617 may be configured to switch the UE 610 from the first RAT (e.g., most recent RAT) to the second RAT as the UE 610 is a multi-mode UE that is capable of supporting multiple RATs for service.

The full band scan circuit 617 may be configured to scan one or more frequencies of a second RAT. If the full band scan circuit 617 determines that service was not acquired based on scanning the first frequency of the second RAT because, for example, the UE 610 did not identify a signal associated with the first frequency associated with the second RAT (e.g., RAT2) on which service may be acquired, the full band scan circuit 617 may be configured to scan for a second frequency associated with the second RAT. In another aspect, the full band scan circuit 617 may be configured to continue this process until the full band scan circuit 617 either identifies a signal on which service may be acquired, or it exhausts all frequencies of the second RAT.

In some examples, where no signal on which service may be acquired has been found as a result of the full band scan of the second RAT, the camping and registration circuit 612, upon receiving such an indication as the scan result 626, may be configured to end processing and allow the UE 610 to remain in the out-of-service state first identified by the service determiner 611. In an aspect, the UE 610 may be configured to attempt to acquire service again, after, for example, a particular amount of time has elapsed, channel quality has increased, the UE 610 has changed geographic locations, a user has so requested, and/or the like. In an aspect, this procedure may be repeated for all supportable RATs, and the UE 610 may remain in an out-of-service state if the UE 610 fails to acquire service. Some or all of the functions described with respect to the service determiner 611, the camping and registration circuit 612, and/or the available PLMN data store 613, may be part of the NAS layer of UE 610. In an aspect, some or all of the functions described with respect to camping and registration circuit 612, available PLMN data store 613, scanning circuit 615, and/or ACQ DB 619 may be part of a lower layer radio resource, e.g., an RRC or RR layer, depending on the current RAT.

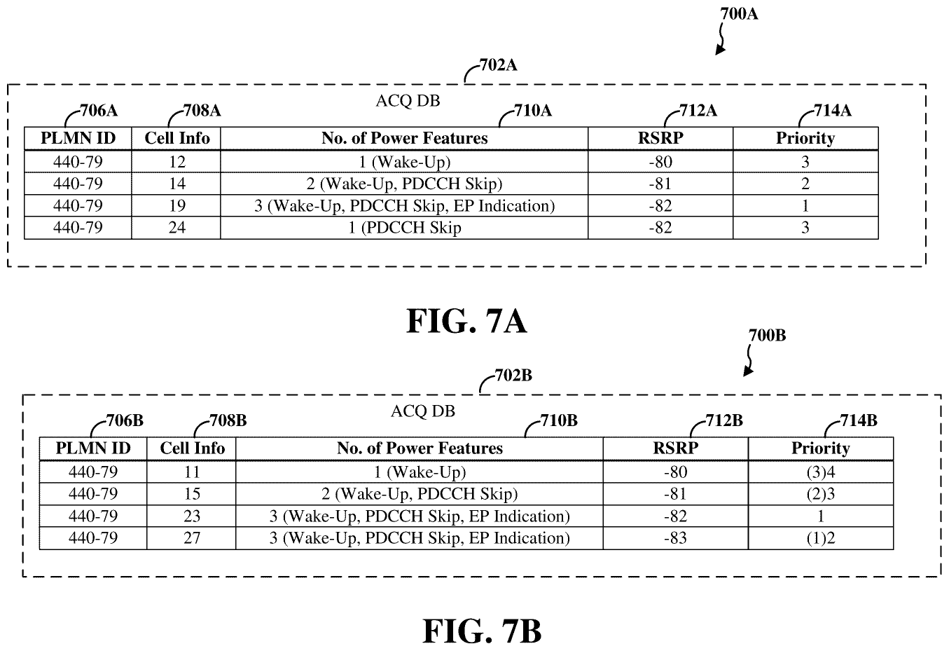

As described herein, the ACQ DB 619 may be configured with other details regarding cell information data and used for cell selection. FIGS. 7A and 7B illustrate ACQ DB configurations, such as a first example ACQ DB configuration 700A in FIG. 7A and a second example ACQ DB configuration 700B in FIG. 7B that may be used in a wireless communication system for receiving a number of power features included in each of a plurality of cells for prioritizing cell connections according to some aspects. The data of ACQ DB 702A and/or 702E may be received by a UE as part of cell reselection data received from a serving cell. In some examples, the ACQ DBs 702A, 702B may be used and operated alternately and/or in addition to the ACQ DB 619 of the system 600 discussed in connection with FIG. 6.

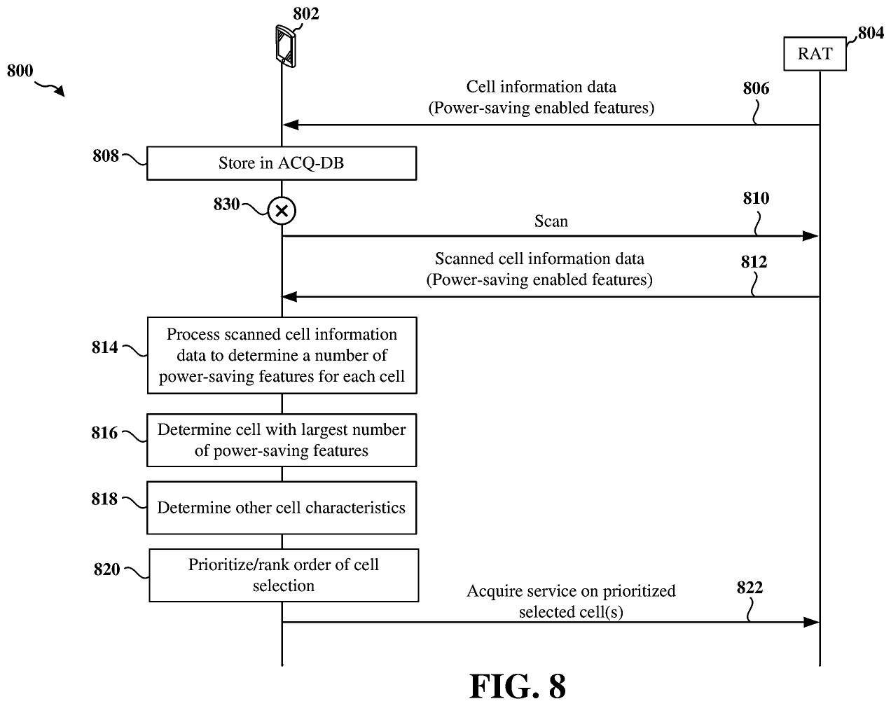

Turning to FIG. 7A, the ACQ DB 702A may include cell data 706A identifying a PLMN (PLMN ID), as well as cell information 708A. Furthermore, an entry identifying a number of power features (also referred to as “power saving features”) 710A enabled for each cell may be included, along with an RSRP value 712A and a cell selection priority value 714A. In this example, the number of power features entry 710A may include network-enabled power saving features including, but not limited to, a wake-up signal capability, a PDCCH skip capability, early paging indication and long DRX capabilities (also referred to as long-connected mode discontinuous reception (C-DRX) messaging), which are discussed in greater detail below in connection with FIGS. 8-12.

As the UE 610 receives cell information data for each cell, the enabled power features are determined and assigned a count as shown in FIG. 7A. Thus, if a cell only has wake-up signal capability enabled, the number of enabled power features would be one. Similarly, if another cell has wake-up and PDCCH skip capabilities enabled, the number of enabled power features would be two. Also, if a further cell has wake-up, PDCCH skip, and early paging indication capabilities enabled, the number of enabled power features would be three, and so on. It should be understood that the power-saving features are provided for illustrative purposes only, and that other power-saving features (e.g., long DRX) are contemplated in the present disclosure.

As can be seen in FIG. 7A, once the number of enabled power features are counted for each cell, an ACQ DB scan circuit (e.g., the ACQ DB scan circuit 616) may rank and prioritize the cells based on their number of enabled power features. In this example, cell 19 is determined to have the largest number of enabled power features (e.g., three enabled power features including wake-up, PDCCH skip, and early paging indication), and is therefore ranked as first in priority for the UE 610 when acquiring service. In other words, the cell (e.g., cell 19) having the largest number of power features may be assigned the highest priority. Likewise, cell 14 is ranked second in priority for the UE 610 when acquiring service, and cells 12 and 24 are ranked third in priority for the UE 610 when acquiring service. In some aspects, the ACQ DB scan circuit 616 may prioritize cells above neighboring cells indicated in a system information block (SIB) message (e.g., a SIB1 message).

A priority selection circuit 621 may be configured to attempt to acquire service from each cell in the order of priority (also referred to as an order of cell selection) determined by the ACQ DB scan circuit 616. If the UE 610 cannot acquire service from the highest ranked cell, the UE 610 then proceeds to attempt to acquire service from the next cell in the priority order until the UE 610 is successful in acquiring service. In some examples, the priority selection circuit 621 may be configured as a separate circuit from the ACQ DB scan circuit 616. In some examples, the priority selection circuit 621 may be integrated with the ACQ DB scan circuit 616 as a single circuit.

In some examples, the ranking of cells by the ACQ DB scan circuit 616 may result in different cells having the same number of power features, thus resulting in an identical priority ranking. FIG. 7B shows a similar configuration to the one disclosed in FIG. 7A, where the ACQ DB 702B may include cell data 706B identifying a PLMN (PLMN ID), as well as cell information 708B. Furthermore, an entry identifying a number of power features (or “power saving features”) 710B enabled for each cell may be included, along with an RSRP value 712B and a cell selection priority value 714B. In this example, the power features of entry 710B may include network-enabled power saving features including, but not limited to, a wake-up signal capability, a PDCCH skip capability, early paging indication and long DRX capabilities, which are discussed in greater detail below in connection with FIGS. 8-12.

As the UE 610 receives cell information data for each cell, the enabled power features are determined and assigned a count as shown in FIG. 7B. Thus, if a cell only has wake-up signal capability enabled, the number of enabled power features would be one. Similarly, if another cell has wake-up and PDCCH skip capabilities enabled, the number of enabled power features would be two. Also, if a further cell has wake-up, PDCCH skip, and early paging indication capabilities enabled, the number of enabled power features would be three, and so on. It should be understood that the power features are provided for illustrative purposes only, and that other power features (e.g., long DRX) are contemplated in the present disclosure.

Once the UE 610 has counted the number of enabled power features for each cell, the ACQ DB scan circuit 616 and/or priority selection circuit 621 may rank and prioritize the cells based on their number of enabled power features. In this example, cell 23 is determined to have the largest number of power features (e.g., three enabled power features including wake-up, PDCCH skip, and early paging indication), and is therefore ranked as first in priority for the UE 610 when acquiring service. However, cell 27 in this example has the same number of features (e.g., three enabled power features including wake-up, PDCCH skip, and early paging indication) as cell 23 and is also ranked first in priority. Cell 15 is ranked second in priority for the UE 610 when acquiring service, and cell 11 is ranked third in priority for the UE 610 when acquiring service.

Since cells 23 and 27 are both ranked identically (e.g., ranked first or has having highest priority), the ACQ DB scan circuit 616 and/or priority selection circuit 621 may reprioritize cells based on one or more secondary entries in the ACQ DB 702B. In some aspects, the ACQ DB scan circuit 616 and/or priority selection circuit 621 may reprioritize cells by filtering and/or soiling cells based on any secondary entries in the ACQ DB 702B. In one example, the ACQ DB scan circuit 616 may process the RSRP 712B entries and may determine that cell 23 has a higher signal strength (−82 dB) as compared to cell 27 (−83 dB). Accordingly, the ACQ DB scan circuit 616 and/or priority selection circuit 621 may reprioritize the cells to designate cell 23 as the highest priority cell (e.g., by setting the cell selection priority value 714B of cell 23 to “1”), followed by cell 27 (e.g., by setting the cell selection priority value 714B of cell 27 to “2”), cell 15 (e.g., by setting the cell selection priority value 714E of cell 23 to “3”) and cell 11 (e.g., by setting the cell selection priority value 714E of cell 11 to “4”), in order of priority. With respect to FIG. 7B, it should be understood that a cell selection priority value 714B indicated in parentheses represents an initial priority value and that a cell selection priority value 714B indicated without parentheses represents the reprioritized priority value.

Once reprioritized, priority selection circuit 621 may be configured to attempt to acquire service from each cell in the order of priority determined by the ACQ DB scan circuit 616. If the UE 610 cannot acquire service from the highest ranked cell, the UE 610 then proceeds to attempt to acquire service from the next cell in the priority order until the UE 610 is successful in acquiring service. While the example of FIG. 7B illustrates the use of RSRP for reprioritizing cells, one skilled in the art will recognize that other cell characteristics may be used alternately or in addition to RSRP. These cell characteristics include, but are not limited to, cell capability to support a number of carriers, aggregated bandwidth across carrier, MIMO, higher order support, long DRX capabilities, etc.

Accordingly, in some examples, the UE 610 may maintain a database including cells configured to support power-related features (e.g., wake up signal, PDCCH Skip, EP indication, long C-DRX) as well as cell capability to support a number of carriers, aggregated bandwidth across carrier, MIMO, higher order support, RSRP, etc. Along with this, the UE 610 may sort these cells based on previous visitation or connection by the UE 610 based on previously stored rankings. Thus, the UE 610 may maintain cell rankings and dynamically prioritize (e.g., rank) cells, based on a current UE operating condition and/or operating parameter.

In some examples, the UE 610 may be configured to rank cells based upon an operating condition of the UE 610, such as a battery level condition, and an operating parameter of the UE 610. In one example, the operating parameter of the UE 610 may indicate whether the data throughput of the UE 610 is greater than or equal to a threshold value (e.g., a numerical value in units of bits/second). In another example, the operating parameter of the UE 610 may indicate whether the UE 610 is running a higher order application (which may involve the transmission and/or reception of data payloads).

For example, if the UE 610 is in a connected mode while the battery level drops below a configured battery level threshold, and the UE 610 is not running a higher order application (e.g., the UE 610 is not transmitting or receiving data payloads), then the UE 610 may rank and select cells that support the largest number of power-related features, as described herein. However, if the battery level of the UE 610 drops below the configured battery level threshold, and the UE 610 is running a higher order application (e.g., the UE 610 is transmitting and/or receiving data payloads associated with a higher order application), the UE 610 may select cells that support the largest number of power-related features along with cells that support features of the higher order application (also referred to as higher-order features), such as minimum bandwidth and/or latency requirements. This may avoid impact to the data throughput of the UE 610 if the power condition of the UE 610 returns back to normal.

FIG. 8 illustrates a signal flow diagram 800 for prioritizing cell connections according to some aspects. This example illustrates communication between a UE 802 and a RAT 804, where the UE 802 may be configured similar to the UEs 104, 350, or 510 discussed previously in connection with FIGS. 1, 3 and 5, respectively, and RAT 804 may be configured as one or more base stations of a RAN as discussed in FIGS. 1, 3 and 5. In some aspects, some or all of the operations of the UE 802 described with reference to FIG. 8 may be performed by the UE 610 in FIG. 6.

When the UE 802 is in an active mode, the UE 802 may receive cell information 806 (also referred to as cell information data) from one or more cells of the RAT 804, wherein the cell information includes any cell identification and operational characteristics including enabled power-saving features discussed above in connection with FIGS. 5-7B, and stored 808 in an ACQ DB. In some examples, the cell information 806 may be obtained by the UE 802 during active (connected) mode operation, wherein the UE 802 collects cell information (including power features) from each cell in its area, and stores the cell information in the ACQ DB 808

If service for the UE 802 is stopped 830 (e.g., due to low battery, OOS, etc.), the UE 802 may then scan 810 the RAT 804 (e.g., see FIG. 5) to determine cell candidates for acquiring service. The RAT 804 returns scanned cell information data, including power features at 812. At 814, the UE 802 processes the scanned cell information data to determine a number of power-saving features enabled for each cell, as discussed above in connection with FIGS. 7A and 7B. At 816, the UE 802 determines the cell(s) having the largest number of power-saving features. At 818, the UE 802 determines other cell characteristics, such as signal strength, DRX configuration, etc. At 820, the UE 802 prioritizes/ranks the order of cell selection and performs any further filtering (e.g., reprioritizing as described with reference to FIG. 7B) if needed. At 822, the UE 802 proceeds to acquire service on prioritized selected cells in accordance with the determined priority/ranking.

For technologies such as NR, an RRC inactive state may be used to reduce the power consumption of a UE and the connection establishment control overhead. With the RRC inactive state, the UE core-network context information may be kept alive at the last known base station (e.g., an anchor base station, such as an anchor gNB). When the UE transitions back to RRC connected mode, for payload transmission or reception, the current selected base station may acquire the UE context from the anchor base station, and the RRC connection is established accordingly. The RRC inactive state therefore enables a faster RRC connection establishment without the need to establish the core-network connection and respective security keys. When there is data inactivity, the base station may trigger an RRC suspend command to the UE and the UE may enter the RRC inactive state, with the core-network context information kept active. For both the RRC IDLE/inactive states, the UE monitors the configured paging occasions. When a true paging indication is detected and decoded, the UE transitions from an RRC IDLE mode to the RRC connected mode before the payload transmission or reception. However, the UE in the RRC inactive mode may transmit or receive a small payload without transitioning to RRC connected mode.

In some examples, discontinuous reception (DRX) is used for connected-mode UEs to sleep and shut down their transceiver chains for extended periods of time, thereby avoiding excessive battery consumption. A DRX cycle may be defined by a periodic set of wake-up times over which the UE wakes-up/turns on its receiver, and attempts decoding of the configured PDCCH control channels, for detecting a possible scheduling grant. DRX may be configured as long and short cycled DRX. A short DRX cycle may be configured, for example, from 2 ms to 640 ms while a long DRX cycle may be configured from 10 Ins to 10.24 s. Accordingly, the long DRX cycle offers improved UE power saving gain. The UE may configure the sleep state which it may trigger between the DRX ON opportunities, and may include a deep sleep, light sleep, and micro sleep. For each sleep state, the UE may shut down certain components of its RF chain.

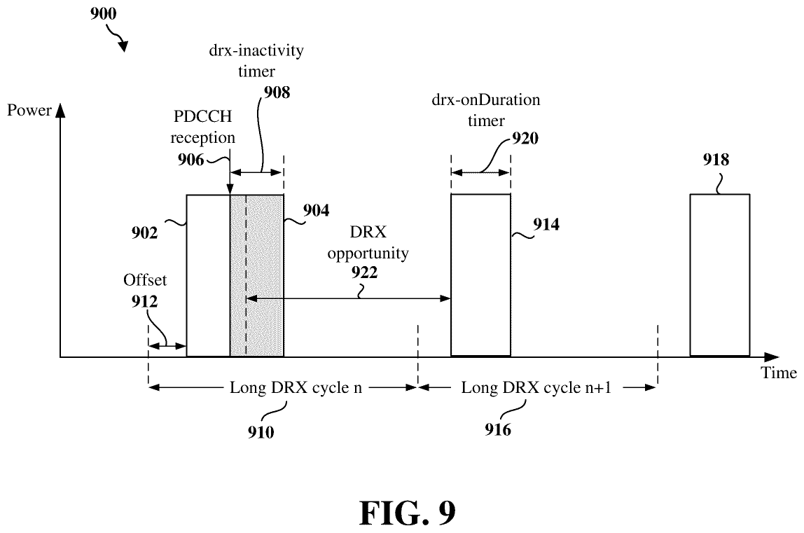

FIG. 9 illustrates a simplified illustration of a discontinuous reception (DRX) operation 900 including a long DRX cycle according to some aspects. In this example, each long DRX cycle (e.g., DRX cycle 910, 916) includes an “on” period and an “off” period. The “on” period also referred to as an “on duration” (e.g., drx-onDuration timer 920) may be defined in terms of milliseconds and may indicate the period in which the UE (e.g., UE 802) would stay awake and decode PDCCH (e.g., PDCCH 902, 914, 918). The “on” and “off” durations together form a long DRX duration and repeat once every long DRX cycle period (e.g., long DRX cycle n 910, long DRX cycle n+1 916) that is configured by RRC. The network can control the start location of the long DRX cycle using an RRC offset parameter 912 that may be defined in milliseconds such that the long DRX cycle could start at a subframe boundary. Additionally, the network can configure start of the “on duration” at slot level granularity within a subframe. The RRC offset parameter 912 (drx-SlotOffset) defines the start of “on duration” relative to the start of subframe boundary. Once a long DRX cycle starts, the UE stays active for a timer duration of (drx-onDurationTimer) and if there is no PDCCH received during this time, the UE would go to DRX sleep state, until the start of next “on duration”.

In some examples, the DRX cycle may include an inactivity timer 908 (also referred to as drx-inactivityTimer) configured by RRC. During operation, the UE may start/restart the inactivity timer 908 every time PDCCH indicates a new UL or DL transmission, and the UE may remain in an active state and may keep monitoring for PDCCH until the expiry of the inactivity timer 908 (inactivity duration). When the UE receives a PDCCH (e.g., PDCCH 902) at 906 indicating a new transmission (DL or UL) on a serving cell of a specific DRX group, the inactivity timer 908 may start or restart of the corresponding DRX group (default or secondary) in the first symbol after the end of the PDCCH reception at 906.

In some examples, when a UE is filtering or reprioritizing cells, as described above in connection with FIG. 7B, the UE may process the DRX configuration to reprioritize the order of cell selection by prioritizing one or more cells having a longest DRX cycle configuration above cells having the largest number of enabled power-saving features.

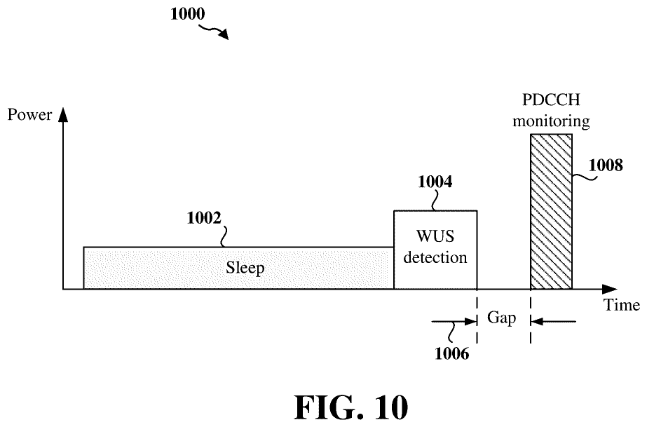

Another power feature that may be utilized by a UE includes a wake-up signal function. FIG. 10 illustrates an example of a wake-up signal function 1000 in a UE (e.g., the UE 802) according to some aspects. A wake-up signal (WUS) may be configured as a physical signal in conjunction with DRX operation that can be decoded or detected before the UE monitors the paging on PDCCH 1008. The UE may reduce unnecessary power consumption related to the PDCCH monitoring by remaining in a sleep mode 1002 and only needs to decode the PDCCH when WUS is detected 1004. The timing of the WUS with respect to the associated paging occasion (PO) may be configured such that the WUS duration is the maximum time duration that is configured by a base station for the UE to detect the WUS. After the WUS is detected, the base station may leave a gap time 1006 to allow the UE to re-synchronize to the base station and eventually switch over from the low-power wake-up receiver to main baseband circuitry in order to be ready to decode the PDCCH 1008.

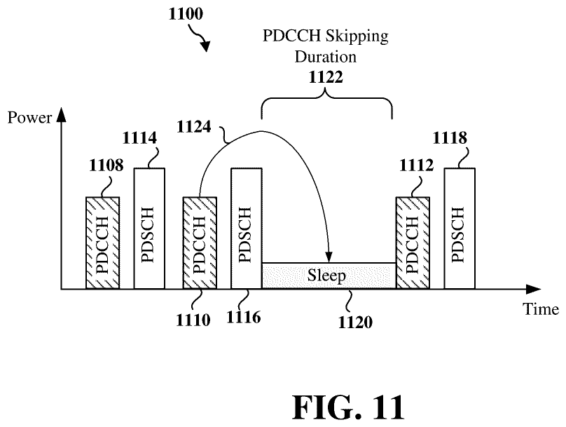

A further power feature that may be utilized by a UE (e.g., the UE 802) includes a PDCCH skipping function. FIG. 11 illustrates an example of a PDCCH skipping function 1100 in a UE according to some aspects. A large portion of UE power consumption is taken up by monitoring the control PDCCH channels (e.g., PDCCH channel 1108, 1110, 1112) and associated PDSCH (e.g., PDSCH 1114, 1116, 1118) during IDLE/Inactive/Connected modes or states for configured durations. Accordingly, a Search Space Set Switching (SSSS) mode may be used, where several search spaces are defined with various periodicity, monitoring duration, certain DCI formats to monitor for, and number of symbols. For latency critical QoS, an SSSS with a shorter periodicity is activated. However, for power-limited UEs, an SSSS with a larger periodicity and shorter duration is signaled.

With PDCCH skipping, as depicted in FIG. 11, a cell (e.g., from the RAT 804) may dynamically signal a power-limited UE with an indication to safely skip (as shown by arrow 1124) monitoring the configured PDCCH control search space for either a certain duration 1122 or until the power-limited UE receives further indication to activate back PDCCH monitoring. This way, different UEs may be configured with the same PDCCH search space, hut with various monitoring patterns. Therefore, UEs configured with PDCCH skipping may sleep 1120 and assume that no traffic will be transmitted during the skipping duration.

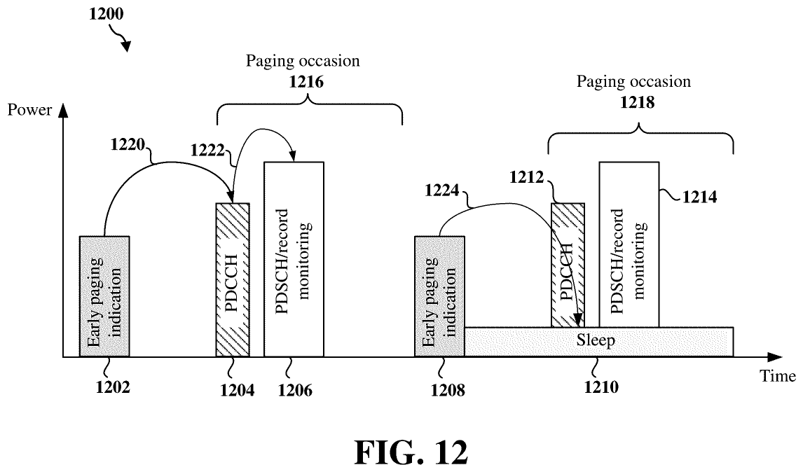

A still further power feature that may be utilized by a UE (e.g., the UE 802) includes utilizing an early page function. FIG. 12 illustrates an example of an early page function 1200 in a UE (e.g., the UE 802) according to some aspects. As discussed above, for mobile terminated communications, UEs periodically monitor configured paging channels to detect upcoming traffic. Thus, a set of periodic POs (e.g., including POs 1216, 1218) is configured, where the IDLE/Inactive UEs monitor various POs (e.g., POs 1216, 1218). A PO may be defined by a PDCCH (e.g., PDCCH 1204, 1212) search space and an associated paging PDSCH record (e.g., PDSCH record 1206, 1214). Thus, UEs monitor the PDCCH search space of the configured PO, and in case there is a paging indication present (e.g., paging indication 1220), the UEs receive and decode the PDSCH (e.g., as indicated at 1222) and become aware of the listed identifiers, (e.g., I-RNTIs) of the UEs that are actually paged. Accordingly, paged UEs trigger the connection establishment procedure while other UEs may transition back to a deep sleep state (e.g., as shown at 1210 in FIG. 12).

A control channel of an early paging indication (EPI) 1202 may be used where the EPI implies a limited-size DCI search space or a sequence, transmitted from a cell prior to each PO (e.g., PO 1216, 1218). An IDLE/Inactive UE may monitor the search space of the EPI, and upon detection of a present EPI indication 1220, the UEs monitor the next, or future, PO. Otherwise, the UE may enter a deep sleep (e.g., as shown at 1210 in FIG. 12) and skip 1224 detecting the PO. Accordingly, the EPI reduces the number of unneeded PO decoding operations.

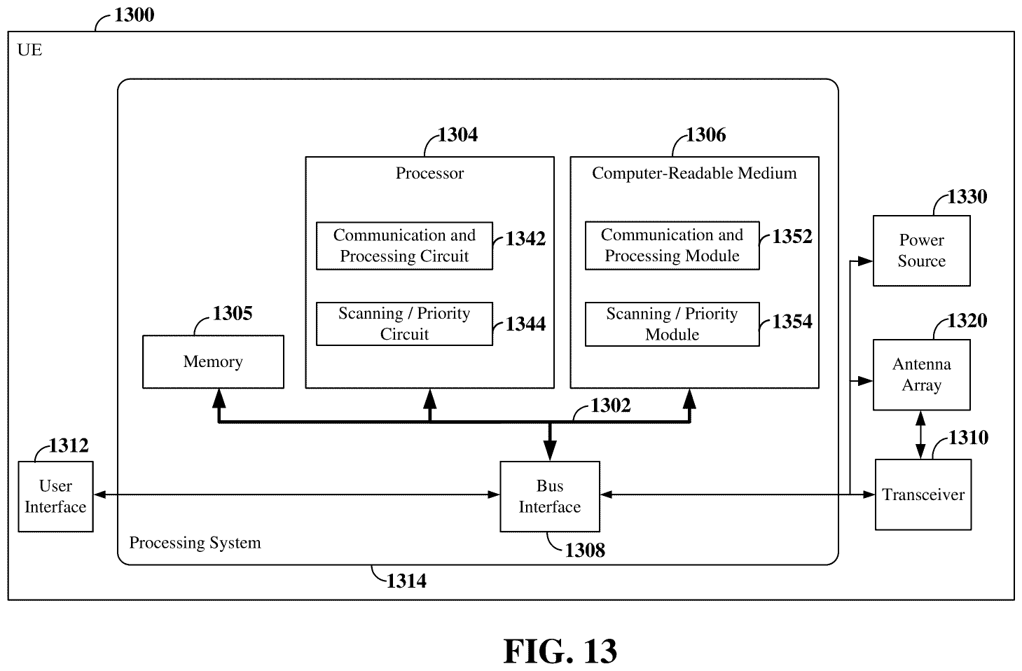

FIG. 13 is a conceptual diagram illustrating an example of a hardware implementation for an exemplary UE 1300 employing a processing system according to some aspects. For example, the UE 1300 may correspond to any of the UEs or other scheduled entities shown and described above in reference to FIGS. 1, 3, 6, and/or 8.

The UE 1300 may be implemented with a processing system 1314 that includes one or more processors 1304. Examples of processors 1304 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1300 may be configured to perform any one or more of the functions described herein. That is, the processor 1304, as utilized in the UE 1300, may be used as a means to implement any one or more of the processes and procedures described herein.

The processor 1304 may in some instances be implemented via a baseband or modem chip and in other implementations, the processor 1304 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1314 may be implemented with a bus architecture, represented generally by the bus 1302. The bus 1302 may include any number of interconnecting buses and bridges depending on the specific application of the processing system 1314 and the overall design constraints. The bus 1302 links together various circuits including one or more processors (represented generally by the processor 1304), a memory 1305, and computer-readable media (represented generally by the computer-readable medium 1306). The bus 1302 may also link various other circuits such as timing sources, peripherals, voltage regulators, and power management circuits, which are well known in the art, and therefore, will not be described any further.

A bus interface 1308 provides an interface between the bus 1302 and a transceiver 1310. The transceiver 1310 provides a communication interface or a means for communicating with various other apparatus over a transmission medium (e.g., air interface). Depending upon the nature of the apparatus, a user interface 1312 (e.g., keypad, display, touch screen, speaker, microphone, control knobs, etc.) may also be provided. Of course, such a user interface 1312 is optional, and may be omitted in some examples.

The UE 1300 may include a power source 1330, such as a battery. The power source 1330 may be coupled to the bus interface 1308.

The processor 1304 is responsible for managing the bus 1302 and general processing, including the execution of software stored on the computer-readable medium. 1306. The software, when executed by the processor 1304, causes the processing system 1314 to perform the various functions described below for any particular apparatus. The computer-readable medium 1306 and the memory 1305 may also be used for storing data that is manipulated by the processor 1304 when executing software. For example, the memory 1305 may store a one or more ACQ DBs (e.g., ACQ DB 702A, 702B), as well as entries associated with cell characteristics (e.g., RSRP) of a cell information database.

One or more processors 1304 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1306.

The computer-readable medium 1306 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium. 1306 may reside in the processing system 1314, external to the processing system 1314, or distributed across multiple entities including the processing system 1314. The computer-readable medium 1306 may be embodied in a computer program product. By way of example, a computer program product may include a computer-readable medium in packaging materials. In some examples, the computer-readable medium. 1306 may be part of the memory 1305. Those skilled in the art will recognize how best to implement the described functionality presented throughout this disclosure depending on the particular application and the overall design constraints imposed on the overall system.

In some aspects of the disclosure, the processor 1304 may include circuitry configured for various functions. For example, the processor 1304 may include communication and processing circuitry 1342, configured to communicate with a base station (e.g., gNB or eNB) via a Uu link. In some examples, the communication and processing circuitry 1342 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1342 may include one or more transmit/receive chains.

In some implementations where the communication involves receiving information, the communication and processing circuitry 1342 may obtain information from a component of the wireless communication device 1300 (e.g., from the transceiver 1310 that receives the information via radio frequency signaling or some other type of signaling suitable for the applicable communication medium), process (e.g., decode) the information, and output the processed information. For example, the communication and processing circuitry 1342 may output the information to another component of the processor 1304, to the memory 1305, or to the bus interface 1308. In some examples, the communication and processing circuitry 1342 may receive one or more of signals, messages, other information, or any combination thereof. In some examples, the communication and processing circuitry 1342 may receive information via one or more channels. In some examples, the communication and processing circuitry 1342 may include functionality for a means for receiving. In some examples, the communication and processing circuitry 1342 may include functionality for a means for processing, including a means for demodulating, a means for decoding, etc.

In some implementations where the communication involves sending (e.g., transmitting) information, the communication and processing circuitry 1342 may obtain information (e.g., from another component of the processor 1304, the memory 1305, or the bus interface 1308), process (e.g., modulate, encode, etc.) the information, and output the processed information. For example, the communication and processing circuitry 1342 may output the information to the transceiver 1310 (e.g., that transmits the information via radio frequency signaling or some other type of signaling suitable for the applicable communication medium). In some examples, the communication and processing circuitry 1342 may send one or more of signals, messages, other information, or any combination thereof. In some examples, the communication and processing circuitry 1342 may send information via one or more channels. In some examples, the communication and processing circuitry 1342 may include functionality for a means for sending (e.g., a means for transmitting). In some examples, the communication and processing circuitry 1342 may include functionality for a means for generating, including a means for modulating, a means for encoding, etc.

In some examples, the communication and processing circuitry 1342 may be configured to transition the UE 1300 between various states, such as RRC connected, RRC inactive, and RRC idle. In some examples, the communication and processing circuitry 1342 may be configured to transmit an RRC suspend request to a RAN to enter an RRC inactive state from an RRC connected state. The communication and processing circuitry 1342 may then be configured to transmit an RRC resume request to the RAN to perform an RRC resume procedure to transition back to the RRC connected state due to RNA update or data transmission. In addition, the communication and processing circuitry 1342 may be configured to transmit an RRC reestablishment request to the RAN to perform an RRC reestablishment procedure to reestablish the RRC connected state upon detecting a failure.

The communication and processing circuitry 1342 may further be configured to transmit uplink data to a RAN upon resuming an RRC connected state from an RRC inactivate state. For example, the communication and processing circuitry 1342 may be configured to identify data in an uplink buffer (e.g., memory 1305) of the UE 1300 and to transmit the uplink data from the uplink buffer. In addition, the communication and processing circuitry 1342 may further be configured to receive a paging message from the RAN indicating that downlink data is present for the UE 1300 in the RAN. The communication and processing circuitry 1342 may then further be configured to receive the downlink data from the RAN upon resuming an RRC connected state from an RRC inactive state. In some examples, communication and processing circuitry 1342 may execute software from communication and processing module 1352 stored on computer-readable medium 1306 to perform these and related functions.

The scanning/priority circuit 1344 may be configured to process scanned frequencies to determine cell information data, and store the cell information data in memory 1305, for example, as a part of one or more ACQ DBs. The scanning/priority circuit 1344 may also be configured to determine a number of power features included in the cell information data and perform additional filtering to (re)prioritize/rank cells for establishing service. In some examples, scanning/priority circuit 1344 may execute software from scanning/priority module 1354 stored on computer-readable medium 1306 to perform these and related functions.

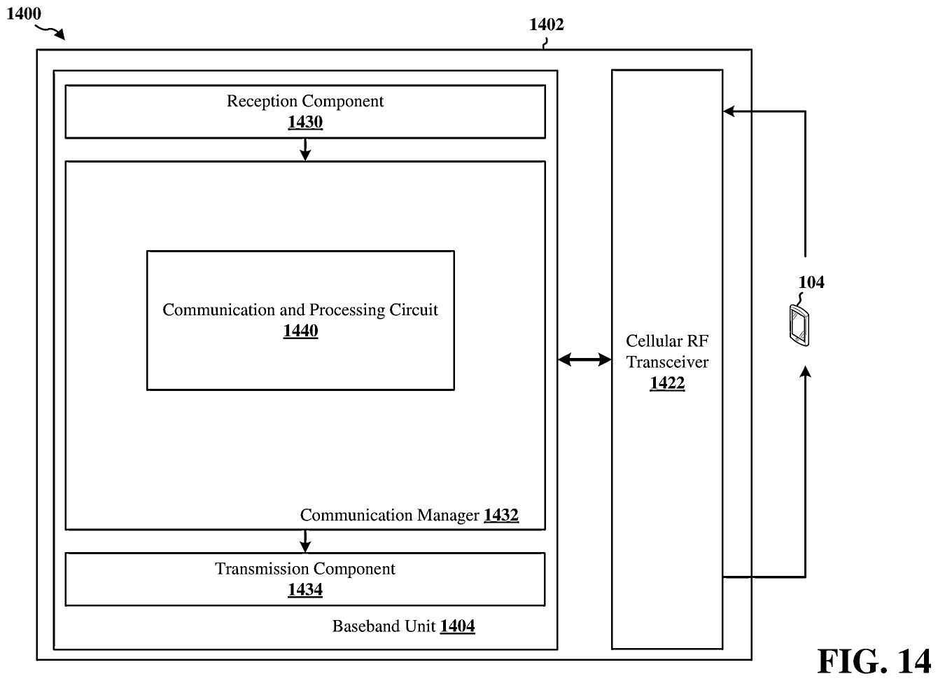

FIG. 14 is a diagram. 1400 illustrating an example of a hardware implementation for an apparatus 1402. The apparatus 1402 may be a base station, a component of a base station, or may implement base station functionality. In some aspects, the apparatus 1402 may include a baseband unit 1404. The baseband unit 1404 may communicate through a cellular RF transceiver 1422 with the UE 104. The baseband unit 1404 may include a computer-readable medium/memory. The baseband unit 1404 is responsible for general processing, including the execution of software stored on the computer-readable medium/memory. The software, when executed by the baseband unit 1404, causes the baseband unit 1404 to perform the various functions described supra. The computer-readable medium/memory may also be used for storing data that is manipulated by the baseband unit 1404 when executing software. The baseband unit 1404 further includes a reception component 1430, a communication manager 1432, and a transmission component 1434. The communication manager 1432 includes the one or more illustrated components. The components within the communication manager 1432 may be stored in the computer-readable medium/memory and/or configured as hardware within the baseband unit 1404. The baseband unit 1404 may be a component of the base station 310 and may include the memory 376 and/or at least one of the TX processor 316, the RX processor 370, and the controller/processor 375.

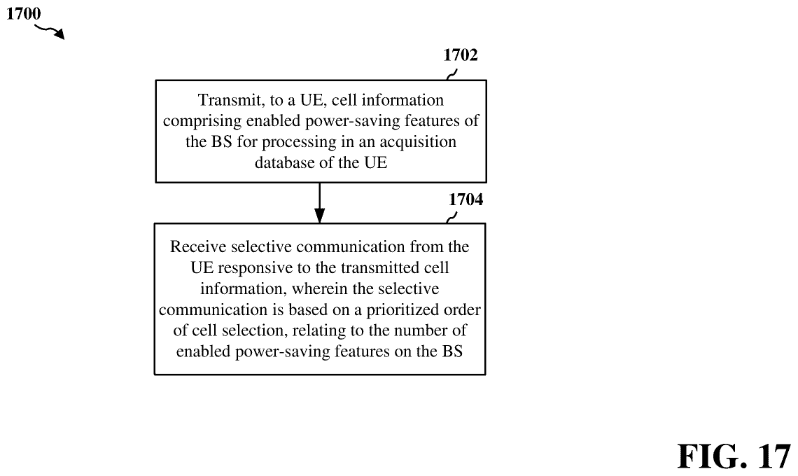

The communication manager 1432 includes a communication and processing circuit 1440 that is configured, e.g., as described in connection with FIG. 17, to transmit, to a UE, cell information comprising enabled power-saving features of the BS for processing in an acquisition database of the UE; and receive selective communication from the UE responsive to the transmitted cell information, wherein the selective communication is based on a prioritized order of cell selection, relating to the number of enabled power-saving features on the BS.

The apparatus may include additional components that perform each of the blocks of the algorithm in the flowchart of FIG. 17. As such, each block in the flowchart of FIG. 17 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1402 may include a variety of components configured for various functions. In one configuration, the apparatus 1402, and in particular the communication and processing circuit 1440, means for transmitting, to a user equipment (UE), cell information comprising enabled power-saving features of the BS for processing in an acquisition database of the UE; and means for receiving selective communication from the UE responsive to the transmitted cell information, wherein the selective communication is based on a prioritized order of cell selection, relating to the number of enabled power-saving features on the BS.

The means may be one or more of the components of the apparatus 1402 configured to perform the functions recited by the means. As described supra, the apparatus 1402 may include the TX Processor 316, the RX Processor 370, and the controller/processor 375. As such, in one configuration, the means may be the TX Processor 316, the RX Processor 370, and the controller/processor 375 configured to perform the functions recited by the means.

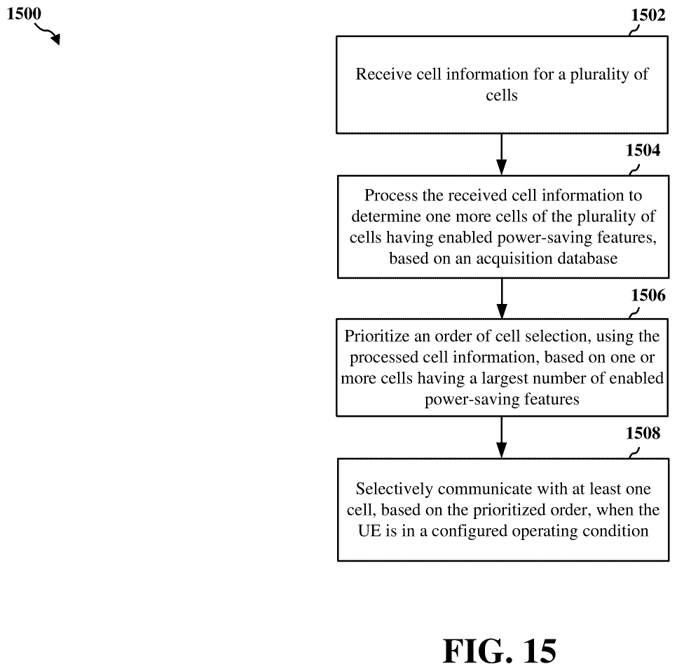

FIG. 15 is a flow chart 1500 of a method for communicating on a wireless network under some aspects of the present disclosure. The method may be performed by a UE. The UE may be any of the UEs described herein, such as UE 104, 350, 610 or 802, discussed above in connection with FIGS. 1, 3, 6 and 8.

In block 1502, the UE may receive cell information for a plurality of cells. The antenna array 1320 and/or transceiver 1310 discussed in connection with FIG. 13 above, may be configured as a means for receiving in some aspects.

In block 1504, the UE may process the received cell information to determine one or more cells of the plurality of cells having enabled power-saving features, based on an acquisition database. In some examples, the power-saving features enabled for a cell may include at least one of a wake-up signal messaging for configuring the UE to remain in an idle state for a configured duration, PDCCH skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration. The processor 1304, communication and processing circuit 1342 and/or scanning/priority circuit 1344 may be configured as a means for processing the received cell information to determine one or more cells of the plurality of cells having enabled power-saving features, based on an acquisition database.

In block 1506, the UE may prioritize an order of cell selection, using the processed cell information, based on one or more cells having a largest number of enabled power-saving features. For example, and as illustrated in the cell selection priority values 714A of FIG. 7A, a cell having the largest number of enabled power-saving features may be assigned the highest priority (e.g., ranked first) while cells having lower numbers of enabled power-saving features may be assigned correspondingly lower priorities (e.g., ranked second, third, etc.). In some examples, the UE may prioritize the order of cell selection by assigning a highest priority for processed cell information comprising long-connected mode discontinuous reception (C-DRX) messaging. The processor 1304, and/or scanning/priority circuit 1344 may be configured as a means for prioritizing an order of cell selection, using the processed cell information, based on one or more cells having a largest number of enabled power-saving features.

In block 1508, the UE may selectively communicate with at least one cell, based on the prioritized order, when the UE is in a configured operating condition. In some examples, the configured operating condition may be a low battery state. For example, the UE may enter a low battery state when a remaining battery power of the UE is less than or equal to a threshold. In other examples, the operating condition may be an OOS or RLF. The processor 1304, communication and processing circuit 1342 and/or scanning/priority circuit 1344 may be configured as a means for selectively communicating with at least one cell, based on the prioritized order, when the UE is in a configured operating condition. The transceiver 1310 and antenna array 1320 may be configured as a means for transmitting the communications.

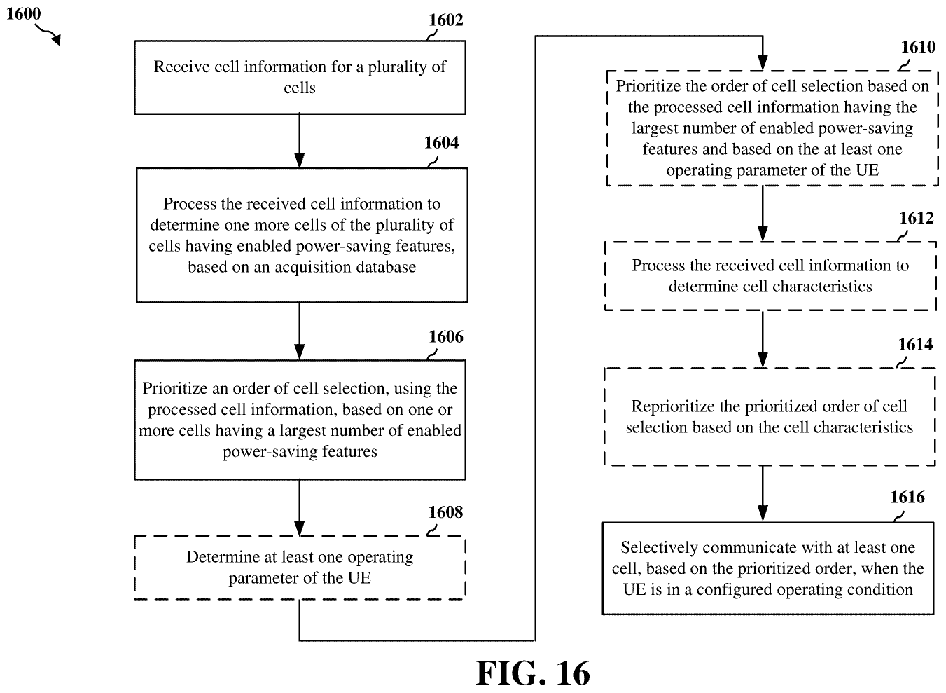

FIG. 16 is a flow chart 1600 of a method for communicating on a wireless network under some aspects of the present disclosure. The method may be performed by a UE. The UE may be any of the UEs described herein, such as UE 104, 350, 610 or 802, discussed above in connection with FIGS. 1, 3, 6 and 8.

In block 1602, a UE (e.g., UE 610, 802) may receive cell information for a plurality of cells. The antenna array 1320 and/or transceiver 1310 discussed in connection with FIG. 13 above, may be configured as a means for receiving in some aspects.

In block 1604, the UE may process the received cell information to determine one or more cells of the plurality of cells having enabled power-saving features, based on an acquisition database. In some examples, the power-saving features enabled for a cell may include at least one of a wake-up signal messaging for configuring the UE to remain in an idle state for a configured duration, PDCCH skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration. The processor 1304, communication and processing circuit 1342 and/or scanning/priority circuit 1344 may be configured as a means for processing the received cell information to determine one or more cells of the plurality of cells having enabled power-saving features, based on an acquisition database.

In block 1606, the UE may prioritize an order of cell selection, using the processed cell information, based on one or more cells having a largest number of enabled power-saving features. For example, and as illustrated in the cell selection priority values 714A of FIG. 7A, a cell having the largest number of enabled power-saving features may be assigned the highest priority (e.g., ranked first) while cells having lower numbers of enabled power-saving features may be assigned correspondingly lower priorities (e.g., ranked second, third, etc.). In some examples, the UE may prioritize the order of cell selection by assigning a highest priority for processed cell information comprising long-connected mode discontinuous reception (C-DRX) messaging. The processor 1304, and/or scanning/priority circuit 1344 may be configured as a means for prioritizing an order of cell selection, using the processed cell information, based on one or more cells having a largest number of enabled power-saving features.

In optional block 1608, the UE may determine at least one operating parameter of the UE. As described herein, for example, the operating parameter of the UE may indicate whether the data throughput of the UE is greater than or equal to a threshold value (e.g., a numerical value in units of bits/second). In another example, the operating parameter of the UE 610 may indicate whether the UE 610 is running a higher order application (which may involve the transmission and/or reception of data payloads).

In optional block 1610, the UE may prioritize the order of cell selection based on the processed cell information having the largest number of enabled power-saving features and based on the at least one operating parameter of the UE. For example, with reference to FIG. 6, if the UE 610 is in a connected mode while the battery level drops below a configured battery level threshold, and the UE 610 is not running a higher order application (e.g., the UE 610 is not transmitting or receiving data payloads), then the UE 610 may rank and select cells that support the largest number of power-related features, as described herein. However, if the battery level of the UE 610 drops below the configured battery level threshold, and the UE 610 is running a higher order application (e.g., the UE 610 is transmitting and/or receiving data payloads associated with a higher order application), the UE 610 may select cells that support the largest number of power-related features along with cells that support features of the higher order application (also referred to as higher-order features), such as minimum bandwidth and/or latency requirements.

In optional block 1612, the UE may process the received cell information to determine cell characteristics. In some examples, the cell characteristics may include an RSRP, cell capability to support a number of carriers, aggregated bandwidth across carrier, MIMO, higher order support, long DRX capabilities, etc. The processor 1304, communication and processing circuit 1342 and/or scanning/priority circuit 1344 may be configured as a means for determining an operating parameter of the UE and processing the received cell information to determine cell characteristics.

In optional block 1614, the UE may reprioritize the prioritized order of cell selection based on the cell characteristics. In one example, with reference to FIG. 7B, the cell characteristics may include an RSRP, such as the RSRP 712B entries. The ACQ DB scan circuit 616 may process the RSRP 712B entries and may determine that cell 23 has a higher signal strength (−82 dB) as compared to cell 27 (−83 dB). Accordingly, the ACQ DB scan circuit 616 and/or priority selection circuit 621 may reprioritize the cells to designate cell 23 as the highest priority cell (e.g., by setting the cell selection priority value 714B of cell 23 to “1”), followed by cell 27 (e.g., by setting the cell selection priority value 714B of cell 27 to “2”), cell 15 (e.g., by setting the cell selection priority value 714B of cell 23 to “3”) and cell 11 (e.g., by setting the cell selection priority value 714B of cell 11 to “4”), in order of priority. The processor 1304 and/or scanning/priority circuit 1344 may be configured as a means for reprioritizing the prioritized order of cell selection based on the cell characteristics.

In block 1616, the UE may selectively communicate with at least one cell, based on the prioritized order, when the UE is in a configured operating condition. In some examples, the configured operating condition may be a low battery state. For example, the UE may enter a low battery state when a remaining battery power of the UE is less than or equal to a threshold. In other examples, the operating condition may be an OOS or RLF. The processor 1304, communication and processing circuit 1342 and/or scanning/priority circuit 1344 may be configured as a means for selectively communicating with at least one cell, based on the prioritized order, when the UE is in a configured operating condition. The transceiver 1310 and antenna array 1320 may be configured as a means for transmitting the communications.

FIG. 17 is a flow chart 1700 of a method for communicating on a wireless network under some aspects of the present disclosure. In block 1702, a BS (e.g., RAT 804) may transmit, to a UE (e.g., UE 802), cell information comprising enabled power-saving features of the BS for processing in an acquisition database of the UE. The communication and processing circuit 1440, and/or transmission component 1434 may be configured as a means for transmitting cell information comprising enabled power-saving features of the BS for processing in an acquisition database of the UE.

In block 1704, the BS may receive a selective communication from the UE responsive to the transmitted cell information, wherein the selective communication is based on a prioritized order of cell selection, relating to the number of enabled power-saving features on the BS. The communication and processing circuit 1440, and/or reception component 1430 may be configured as a means for receiving selective communication from the UE responsive to the transmitted cell information, wherein the selective communication is based on a prioritized order of cell selection, relating to the number of enabled power-saving features on the BS.

One skilled in the art will appreciate that using the technologies and techniques disclosed herein, a UE communicating with a base station/cell may prioritize an order of cell selection using processed cell information based on one or more cells having a largest number of enabled power-saving features, and selectively communicate with at least one cell, based on the prioritized order, when the UE is in a configured operating condition (e.g., a low battery state, OOS, or other appropriate operating condition). Therefore, the aspects described herein may improve the ability of UEs to select cells that support power saving features, thereby reducing the energy/battery consumption at the UE and extending the operating time of the UE in scenarios where the battery life of the UE is low (e.g., below a battery level threshold). The aspects described herein may further enable UEs to establish energy-efficient connections with base stations in an improved manner.

The following provides an overview of aspects of the present disclosure:

Aspect 1: is a method of user equipment (UE) communication on a wireless network, comprising: receiving cell information for a plurality of cells; processing the received cell information to determine one or more cells of the plurality of cells having enabled power-saving features, based on an acquisition database; prioritizing an order of cell selection, using the processed cell information, based on one or more cells having a largest number of enabled power-saving features; and selectively communicating with at least one cell, based on the prioritized order, when the UE is in a configured operating condition.

Aspect 2 may be combined with aspect 1 and includes that the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

Aspect 3 may be combined with any of aspects 1 and/or 2, and includes that prioritizing the order of cell selection comprises assigning a highest priority for processed cell information comprising long-connected mode discontinuous reception (C-DRX) messaging.

Aspect 4 may be combined with any of aspects 1 through 3, and includes that the configured operating condition comprises one of an out-of-service state or a low battery state.

Aspect 5 may be combined with any of aspects 1 through 4, and includes that receiving the cell information for a plurality of cells comprises receiving cell reselection data from a serving cell, wherein the cell reselection data comprises the enabled power-saving features for cells in the cell reselection data, and wherein prioritizing an order of cell selection comprises processing the received cell reselection data to determine one or more cells of the cell reselection data having the largest number of enabled power-saving features, based on the acquisition database.

Aspect 6 may be combined with any of aspects 1 through 5, and further includes determining at least one operating parameter of the UE and prioritizing the order of cell selection, based on the processed cell information having the largest number of enabled power-saving features and based on the at least one operating parameter of the UE.

Aspect 7 may be combined with any of aspects 1 through 6, and includes that the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

Aspect 8 may be combined with any of aspects 1 through 7, and further includes processing the received cell information to determine cell characteristics; and reprioritizing the prioritized order of cell selection based on the cell characteristics.

Aspect 9 is a user equipment (UE) for communicating on a wireless network, comprising: a memory; and at least one processor coupled to the memory and configured to: receive cell information for a plurality of cells; process the received cell information to determine one or more cells of the plurality of cells having enabled power-saving features, based on an acquisition database; prioritize an order of cell selection, using the processed cell information, based on one or more cells having a largest number of enabled power-saving features; and selectively communicate with at least one cell, based on the prioritized order, when the UE is in a configured operating condition.

Aspect 10 may be combined with aspect 9 and includes that the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

Aspect 11 may be combined with any of aspects 9 through 10, and includes that the at least one processor is configured to prioritize the order of cell selection by assigning a highest priority for processed cell information comprising long-connected mode discontinuous reception (C-DRX) messaging.

Aspect 12 may be combined with any of aspects 9 and/or 10, and includes that the configured operating condition comprises one of an out-of-service state or a low battery state.

Aspect 13 may be combined with any of aspects 9 through 12, and includes that the at least one processor is configured to: receive the cell information for a plurality of cells by receiving cell reselection data from a serving cell, wherein the cell reselection data comprises the enabled power-saving features for cells in the cell reselection data, and prioritize the order of cell selection by processing the received cell reselection data to determine one or more cells of the cell reselection data having the largest number of enabled power-saving features, based on the acquisition database

Aspect 14 may be combined with any of aspects 9 through 13, and includes that the at least one processor is configured to determine at least one operating parameter of the UE and prioritize the order of cell selection, based on the processed cell information having the largest number of enabled power-saving features and based on the at least one operating parameter of the UE.

Aspect 15 may be combined with any of aspects 9 through 14, and includes that the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

Aspect 16 may be combined with any of aspects 9 through 15, and includes that the at least one processor is configured to process the received cell information to determine cell characteristics, and reprioritize the prioritized order of cell selection based on the cell characteristics

Aspect 17 is a non-transitory computer-readable medium storing code for wireless communication at a user equipment (UE), the code comprising instructions executable by a processor to: receive cell information for a plurality of cells; process the received cell information to determine one or more cells of the plurality of cells having enabled power-saving features, based on an acquisition database; prioritize an order of cell selection, using the processed cell information, based on one or more cells having a largest number of enabled power-saving features; and selectively communicate with at least one cell, based on the prioritized order, when the UE is in a configured operating condition.

Aspect 18 may be combined with aspect 17 and includes that the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

Aspect 19 may be combined with any of aspects 1 and/or 18, and includes that the instructions are further executable to prioritize the order of cell selection by assigning a highest priority for processed cell information comprising long-connected mode discontinuous reception (C-DRX) messaging.

Aspect 20 may be combined with any of aspects 1 through 19, and includes that the configured operating condition comprises one of an out-of-service state or a low battery state.

Aspect 21 may be combined with any of aspects 1 through 20, and includes that the instructions are further executable to receive the cell information for a plurality of cells by receiving cell reselection data from a serving cell, wherein the cell reselection data comprises the enabled power-saving features for cells in the cell reselection data, and wherein the instructions are further executable to prioritize an order of cell selection by processing the received cell reselection data to determine one or more cells of the cell reselection data having the largest number of enabled power-saving features, based on the acquisition database

Aspect 22 may be combined with any of aspects 1 through 21, and includes that the instructions are further executable to determine at least one operating parameter of the UE and prioritize the order of cell selection, based on the processed cell information having the largest number of enabled power-saving features and based on the at least one operating parameter of the UE.

Aspect 23 may be combined with any of aspects 1 through 22, and includes that the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

Aspect 24 may be combined with any of aspects 1 through 23, and includes that the instructions are further executable to process the received cell information to determine cell characteristics, and reprioritize the prioritized order of cell selection based on the cell characteristics.

Aspect 25 is an apparatus for wireless communication at a base station (BS), comprising: a memory; and at least one processor coupled to the memory and configured to: transmit, to a user equipment (UE), cell information comprising enabled power-saving features of the BS for processing in an acquisition database of the UE; and receive selective communication from the UE responsive to the transmitted cell information, wherein the selective communication is based on a prioritized order of cell selection, relating to the number of enabled power-saving features on the BS.

Aspect 26 may be combined with aspect 25 and includes that the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

Aspect 27 may be combined with any of aspects 25 and/or 26, and includes that the at least one processor is configured to: transmit cell reselection data, wherein the cell reselection data comprises enabled power-saving features for the UE to determine if the BS has the largest number of enabled power-saving features, based on the acquisition database, wherein the selective communication is related to a prioritized order of cell reselection by the UE.

Aspect 28 may be combined with any of aspects 25 through 27, and includes that the at least one processor is configured to receive selective communication from the UE based on an operating parameter of the UE.

Aspect 29 may be combined with any of aspects 25 through 28, and includes that the enabled power-saving features comprise a discontinuous reception (DRX) configuration, and wherein the at least one processor is configured to receive selective communication from the UE based on the BS having a longest DRX cycle configuration above other cells having the largest number of enabled power-saving features.

Aspect 30 may be combined with any of aspects 25 through 29, and includes that the at least one processor is configured to transmit cell information for filtering by the UE to determine the prioritized order of cell selection.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C;” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of user equipment (UE) communication on a wireless ne work, comprising:
receiving cell information for a plurality of cells;
processing the received cell information to determine one or more cells of the plurality of cells having enabled power-saving features, based on an acquisition database;
prioritizing an order of cell selection, using the processed cell information, based on one or more cells having a largest number of enabled power-saving features; and
selectively communicating with at least one cell, based on the prioritized order, when the UE is in a configured operating condition.

2. The method of claim 1, wherein the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the LIE in advance of a future paging occasion, or long-connected mode discontinuous reception (C-DRX) messaging for extending an active state of the UE using a configured length of inactivity duration.

3. The method of claim 2, wherein prioritizing the order of cell selection comprises assigning a highest priority for processed cell information comprising long-connected mode discontinuous reception (C-DRX) messaging.

4. The method of claim 1, wherein the configured operating condition comprises one of an out-of-service state or a low battery state.

5. The method of claim 1, wherein receiving the cell information for a plurality of cells comprises receiving cell reselection data from a serving cell, wherein the cell reselection data comprises the enabled power-saving features for cells in the cell reselection data, and wherein prioritizing an order of cell selection comprises processing the received cell reselection data to determine one or more cells of the cell reselection data having the largest number of enabled power-saving features, based on the acquisition database.

6. The method of claim 1, further comprising:
determining at least one operating parameter of the UE; and
prioritizing the order of cell selection based on the processed cell information having the largest number of enabled power-saving features and based on the at least one operating parameter of the UE.

7. The method of claim 1, wherein the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

8. The method of claim 1, further comprising:
processing the received cell information to determine cell characteristics; and
reprioritizing the prioritized order of cell selection based on the cell characteristics.

9. A user equipment (UE) for wireless communication on a wireless network, comprising:
a memory; and
at least one processor coupled to the memory and configured to:
receive cell information for a plurality of cells;
process the received cell information to determine one or more cells of the plurality of cells having enabled power-saving features, based on an acquisition database;
prioritize an order of cell selection, using the processed cell information, based on one or more cells having a largest number of enabled power-saving features; and
selectively communicate with at least one cell, based on the prioritized order, when the UE is in a configured operating condition.

10. The UE of claim 9, wherein the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

11. The UE of claim 10, wherein the at least one processor is configured to prioritize the order of cell selection by assigning a highest priority for processed cell information comprising long-connected mode discontinuous reception (C-DRX) messaging.

12. The LIE of claim 9, wherein the configured operating condition comprises one of an out-of-service state or a low battery state.

13. The UE of claim 9, wherein the at least one processor is configured to:
receive the cell information for a plurality of cells by receiving cell reselection data from a serving cell, wherein the cell reselection data comprises the enabled power-saving features for cells in the cell reselection data, and
prioritize the order of cell selection by processing the received cell reselection data to determine one or more cells of the cell reselection data having the largest number of enabled power-saving features, based on the acquisition database.

14. The UE of claim 9, wherein the at least one processor is configured to:
determine at least one operating parameter of the UE; and
prioritize the order of cell selection, based on the processed cell information having the largest number of enabled power-saving features and based on the at least one operating parameter of the UE.

15. The UE of claim 9, wherein the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

16. The LIE of claim 9, wherein the at least one processor is configured to:
process the received cell information to determine cell characteristics; and
reprioritize the prioritized order of cell selection based on the cell characteristics.

17. A non-transitory computer-readable medium storing code for wireless communication at a user equipment (UE), the code comprising instructions executable by a processor to:
receive cell information for a plurality of cells;
process the received cell information to determine one or more cells of the plurality of cells having enabled power-saving features, based on an acquisition database;
prioritize an order of cell selection, using the processed cell information, based on one or more cells having a largest number of enabled power-saving features; and
selectively communicate with at least one cell, based on the prioritized order, when the UE is in a configured operating condition.

18. The non-transitory computer-readable medium of claim 17, wherein the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the LIE using a configured length of inactivity duration.

19. The non-transitory computer-readable medium of claim 18, wherein the instructions are further executable to prioritize the order of cell selection by assigning a highest priority for processed cell information comprising long-connected mode discontinuous reception (C-DRX) messaging.

20. The non-transitory computer-readable medium of claim 17, wherein the configured operating condition comprises one of an out-of-service state or a low battery state.

21. The non-transitory computer-readable medium of claim 17,
wherein the instructions are further executable to receive the cell information for a plurality of cells by receiving cell reselection data from a serving cell, wherein the cell reselection data comprises the enabled power-saving features for cells in the cell reselection data, and
wherein the instructions are further executable to prioritize an order of cell selection by processing the received cell reselection data to determine one or more cells of the cell reselection data having the largest number of enabled power-saving features, based on the acquisition database.

22. The non-transitory computer-readable medium of claim 17, wherein the instructions are further executable to:
determine at least one operating parameter of the LIE; and
prioritize the order of cell selection, based on the processed cell information having the largest number of enabled power-saving features and based on the at least one operating parameter of the UE.

23. The non-transitory computer-readable medium of claim 17, wherein the enabled power-saving features comprise a discontinuous reception (DRX) configuration, and wherein prioritizing the order of cell selection comprises prioritizing one or more cells having a longest DRX cycle configuration above cells having the largest number of enabled power-saving features.

24. The non-transitory computer-readable medium of claim 17, wherein the instructions are further executable to:
process the received cell information to determine cell characteristics; and
reprioritize the prioritized order of cell selection based on the cell characteristics.

25. A base station (BS) for wireless communication, comprising:
a memory; and
at least one processor coupled to the memory and configured to:
transmit, to a user equipment (UE), cell information comprising enabled power-saving features of the BS for processing in an acquisition database of the UE; and
receive selective communication from the UE responsive to the transmitted cell information, wherein the selective communication is based on a prioritized order of cell selection, relating to the number of enabled power-saving features on the BS.

26. The BS of claim 25, wherein the enabled power-saving features includes at least one of a wake-up signal messaging for configuring the UE to remain in an idle state for a configured duration, physical downlink control channel (PDCCH) skip messaging for configuring the UE to skip monitoring a PDCCH search space for a configured duration, early paging indication messaging for notifying the UE in advance of a future paging occasion, or long-connected mode discontinuous reception (C-DRX) messaging for extending an active state of the UE using a configured length of inactivity duration.

27. The BS of claim 25, wherein the at least one processor is further configured to:
transmit cell reselection data, wherein the cell reselection data comprises enabled power-saving features for the UE to determine if the BS has the largest number of enabled power-saving features, based on the acquisition database, wherein the selective communication is related to a prioritized order of cell reselection by the UE.

28. The BS of claim 25, wherein the at least one processor is further configured to:
receive selective communication from the UE based on an operating parameter of the UE.

29. The BS of claim 25, wherein the enabled power-saving features comprise a discontinuous reception (DRX) configuration, and wherein the at least one processor is further configured to:
receive selective communication from the UE based on the BS having a longest DRX cycle configuration above other cells having the largest number of enabled power-saving features.

30. The BS of claim 25, wherein the at least one processor is further configured to:
transmit cell information for filtering by the UE to determine the prioritized order of cell selection.
